(19) United States
(12) Patent Application Publication
(10) Pub. No.: US 2011/0075042 A1
(43) Pub. Date: Mar. 31, 2011

(54) Method and System for Advanced Motion Detection and Decision Mechanism for a Comb Filter in an Analog Video Decoder

(76) Inventors: Dongjian Wang, Shanghai (CN); Qiang Zhu, Shanghai (CN); Xavier Lacarelle, Bagnolet (FR); Chuan Chen, Shanghai (CN); XiaoHong Di, Shanghai (CN); Wu Huang, Shanghai (CN)

(21) Appl. No.: 12/570,541

(22) Filed: Sep. 30, 2009

(51) Int. Cl. H04N 9/00

(52) U.S. Cl. 348/669; 348/E09.001

(57) ABSTRACT

Aspects of a method and system for an advanced motion detection and decision mechanism for a comb filter in an analog video decoder are provided. A spatial luma component and a spatial chroma component of a current pixel of a composite video baseband signal may be determined by a spatial comb filter. A temporal luma component and a temporal chroma component of the current pixel of the composite video baseband signal may be determined by one or more temporal comb filters. A motion level of the current pixel may be generated based on one or more video characteristics. A luma component and a chroma component of the current pixel of the composite video baseband signal may be generated based on the generated motion level and determined spatial luma component, spatial chroma component, temporal luma component, and temporal chroma component of the current pixel of the composite video baseband signal.

### CROSS-REFERENCE TO RELATED APPLICATIONS/INCORPORATION BY REFERENCE

None.

### FIELD OF THE INVENTION

Certain embodiments of the invention relate to video processing. More specifically, certain embodiments of the invention relate to a method and system for an advanced motion detection and decision mechanism for a comb filter in an analog video decoder.

### BACKGROUND OF THE INVENTION

Analog video may be received through broadcast, cable, and VCRs. The reception is often corrupted by noise, and therefore to improve the visual quality, noise reduction may be needed. Digital video may be received through broadcast, cable, satellite, Internet, and video discs. Digital video may be corrupted by noise, which may include coding artifacts, and to improve the visual quality and coding gain, noise reduction may be beneficial. Various noise filters have been utilized in video communication systems such as set top boxes. However, inaccurate noise characterization, especially during scenes with motion, may result in artifacts caused by the filtering, which are more visually detrimental than the original noise.

In video system applications, random noise present in video signals, such as National Television System(s) Committee (NTSC) or Phase Alternating Line (PAL) analog signals, for example, may result in images that are less than visually pleasing to the viewer and the temporal noise may reduce the video encoder coding efficiency. As a result, the temporal noise may affect the video quality of the encoded video stream with a given target bitrate. To address this problem, spatial and temporal noise reduction (NR) operations may be utilized to remove or mitigate the noise present. Traditional NR operations may use either infinite impulse response (IIR) filtering based methods or finite impulse response (FIR) filtering based methods. Temporal filtering may be utilized to significantly attenuate temporal noise. However, temporal filtering may result in visual artifacts such as motion trails, jittering, and/or wobbling at places where there is object motion when the amount of filtering is not sufficiently conservative. Spatial filtering may attenuate significantly high frequency noise or some narrow pass disturbing signals. However, spatial filtering may also attenuate the content spectrum, which may introduce blurriness artifacts in the active spatial filter areas.

Color information carried by a composite television (TV) signal may be modulated in quadrature upon a subcarrier. The subcarrier may have a frequency corresponding to the line scan frequency in a manner that may interleave the color information about the subcarrier between energy spectra of the luminance baseband signal. In color television systems such as NTSC and PAL, the color information comprises luminance (Y) and chrominance (C) information sharing a portion of the total signal bandwidth. Thus, a Y/C separation procedure in the receiving end may be required to extract the luminance and chrominance information individually. The luminance and chrominance information of some image areas, especially in image areas such as a motion edge of high frequency luminance, may not be distinguishable due to imperfect encoding techniques. For example, a television demodulator may incorrectly demodulate high frequency luminance information as chrominance information, causing color artifacts on vertical edges. These color artifacts may include, for example, color ringing, color smearing, and the display of color rainbows in place of high-frequency gray-scale information.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for an advanced motion detection and decision mechanism for a comb filter in an analog video decoder, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary video processing system, in accordance with an embodiment of the invention.

FIG. 2 is a diagram illustrating exemplary consecutive video pictures for Y/C separation operations, in connection with an embodiment of the invention.

FIG. 3A is a diagram of an exemplary embodiment of a distribution of NTSC composite video baseband pixels in spatial and temporal domains, in accordance with an embodiment of the invention.

FIG. 3B is a diagram of an exemplary embodiment of a distribution of NTSC composite video baseband pixels in spatial and temporal domains with one frame delay, in accordance with an embodiment of the invention.

FIG. 3C is a diagram of an exemplary embodiment of a distribution of PAL composite video baseband pixels in spatial and temporal domains, in accordance with an embodiment of the invention.

FIG. 4 is a block diagram of an exemplary spatial comb filter for Y/C separation operations, in accordance with an embodiment of the invention.

FIG. 5 is a block diagram of an exemplary 3D motion adaptive temporal comb filter for Y/C separation operations, in accordance with an embodiment of the invention.

FIG. 6 is a block diagram of an exemplary advanced motion detection system for Y/C separation operations, in accordance with an embodiment of the invention.

FIG. 7 is a block diagram of an exemplary advanced motion detection and decision mechanism for a comb filter in an analog video decoder for Y/C separation operations, in accordance with an embodiment of the invention.

FIG. 8 is a flowchart illustrating exemplary steps for an advanced motion detection and decision mechanism for a comb filter in an analog video decoder for Y/C separation operations, in accordance with an embodiment of the invention.

### DETAILED DESCRIPTION OF THE INVENTION

Certain embodiments of the invention may be found in a method and system for an advanced motion detection and decision mechanism for 3D comb filter in an analog video decoder. In various embodiments of the invention, a spatial luma component and a spatial chroma component of a current pixel of a composite video baseband signal may be determined by a spatial comb filter. A temporal luma component and a temporal chroma component of the current pixel of the composite video baseband signal may be determined by one or more temporal comb filters. A motion level of the current pixel may be generated based on one or more video characteristics. A luma component and a chroma component of the current pixel of the composite video baseband signal may be generated based on the generated motion level, and determined spatial luma component, determined spatial chroma component, determined temporal luma component, and determined temporal chroma component of the current pixel of the composite video baseband signal.

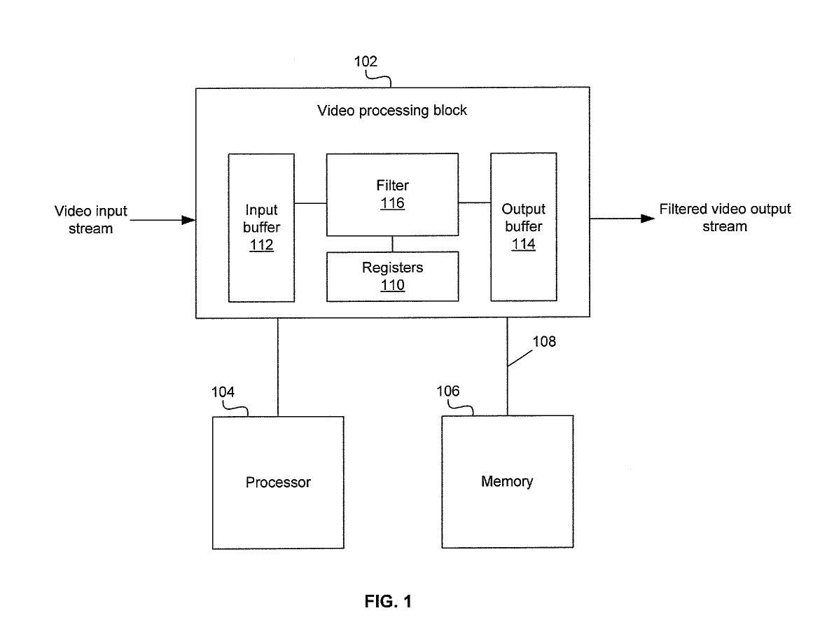

FIG. 1 is a block diagram of an exemplary video processing system, in accordance with an embodiment of the invention. Referring to FIG. 1, there is shown a video processing block 102, a processor 104, a memory 106, and a data/control bus 108. The video processing block 102 may comprise registers 110 and filter 116. In some instances, the video processing block 102 may also comprise an input buffer 112 and/or an output buffer 114. The video processing block 102 may comprise suitable logic, circuitry, interfaces, and/or code that may be operable to filter pixels in a video picture from a video input stream to separate luma (Y) and chroma (C) components. For example, video frame pictures may be utilized in video systems with progressive video signals while video field pictures may be utilized in video systems with interlaced video signals. Video fields may alternate parity between top fields and bottom fields. A top field and a bottom field in an interlaced system may be deinterlaced or combined to produce a video frame.

The video processing block 102 may be operable to receive a video input stream and, in some instances, to buffer at least a portion of the received video input stream in the input buffer 112. In this regard, the input buffer 112 may comprise suitable logic, circuitry, interfaces, and/or code that may be operable to store at least a portion of the received video input stream. Similarly, the video processing block 102 may be operable to generate a filtered video output stream and, in some instances, to buffer at least a portion of the generated filtered video output stream in the output buffer 114. In this regard, the output buffer 114 may comprise suitable logic, circuitry, interfaces, and/or code that may be operable to store at least a portion of the filtered video output stream.

The filter 116 in the video processing block 102 may comprise suitable logic, circuitry, interfaces, and/or code that may be operable to perform comb and/or notch filtering operations on a current pixel in a video picture to separate Y and C components. In this regard, the filter 116 may be operable to operate in a plurality of filtering modes, where each filtering mode may be associated with one of a plurality of supported filtering operations. The filter 116 may utilize video content, filter coefficients, threshold levels, and/or constants to generate the filtered video output stream in accordance with the filtering mode selected. In this regard, the video processing block 102 may generate blending factors to be utilized with the appropriate filtering mode selected. The registers 110 in the video processing block 102 may comprise suitable logic, circuitry, interfaces, and/or code that may be operable to store information that corresponds to filter coefficients, threshold levels, and/or constants, for example. Moreover, the registers 110 may be operable to store information that correspond to a selected filtering mode.

The processor 104 may comprise suitable logic, circuitry, interfaces, and/or code that may be operable to process data and/or perform system control operations. The processor 104 may be operable to control at least a portion of the operations of the video processing block 102. For example, the processor 104 may generate at least one signal to control the selection of the filtering mode in the video processing block 102. Moreover, the processor 104 may be operable to program, update, and/or modify filter coefficients, threshold levels, and/or constants in at least a portion of the registers 110. For example, the processor 104 may generate at least one signal to retrieve stored filter coefficients, threshold levels, and/or constants that may be stored in the memory 106 and transfer the retrieved information to the registers 110 via the data/control bus 108. The memory 106 may comprise suitable logic, circuitry, interfaces, and/or code that may be operable to store information that may be utilized by the video processing block 102 to separate Y and C components in the video input stream. The memory 106 may be operable to store filter coefficients, threshold levels, and/or constants, for example, to be utilized by the video processing block 102.

In operation, the processor 104 may program the appropriate values for the filter coefficients, threshold levels, and/or constants into the registers 110 in accordance with the selected filtering mode. The video processing block 102 may receive the video input stream and may filter pixels in a video picture. In some instances, the video input stream may be stored in the input buffer 112 before processing. The video processing block 102 may generate the appropriate blending factors needed to perform the Y/C separation filtering operation selected by the processor 104. The video processing block 102 may generate the filtered video output stream after performing the Y/C separation filtering operation. In some instances, the filtered video output stream may be stored in the output buffer 114 before being transferred out of the video processing block 102.

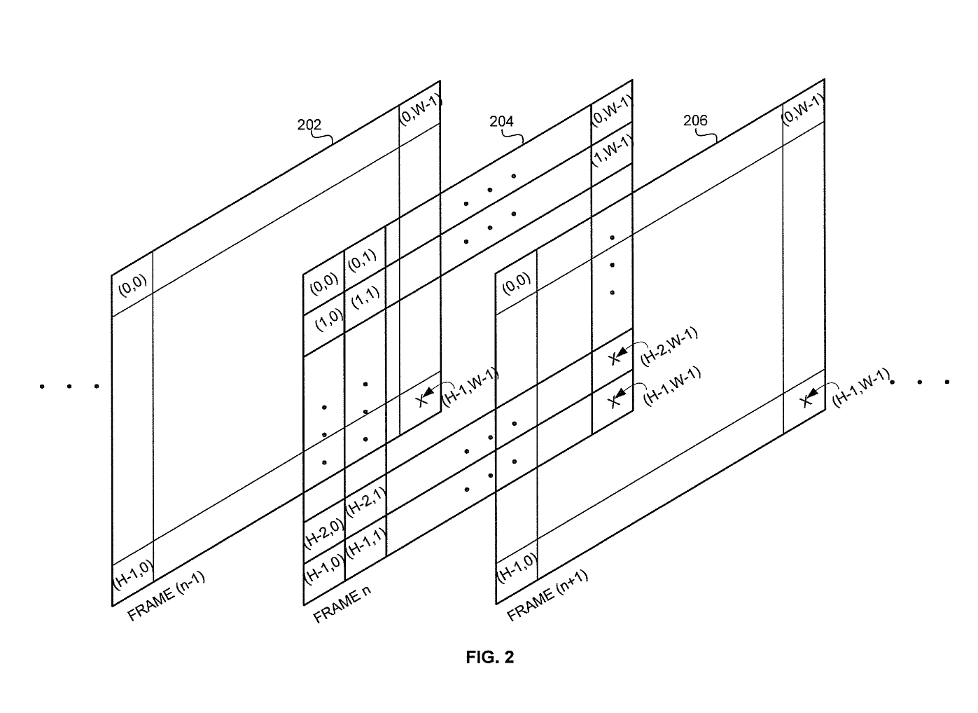

FIG. 2 is a diagram illustrating exemplary consecutive video pictures for Y/C separation operations, in connection with an embodiment of the invention. Referring to FIG. 2, there is shown a current video picture 204, a previous video picture 202, and a next video picture 206. The current video picture 204 or PICTURE n may correspond to a current picture being processed by the video processing block 102 in FIG. 1. The previous video picture 202 or PICTURE (n−1) may correspond to an immediately previous picture to the current video picture 204. The next video picture 206 or PICTURE (n+1) may correspond to an immediately next picture to the current video picture 204. The previous video picture 202, the current video picture 204, and/or the next video picture 206 may be processed directly from the video input stream or after being buffered in the video processing block 102, for example. The current video picture 204, the previous video picture 206, and the next video picture 208 may comprise luma (Y) and/or chroma (Cb, Cr) information. In embodiments of the invention, where video fields are utilized as pictures, the previous video picture 202 may refer to the previous field of the same parity as the current video picture 204, and the next video picture 206 may refer to the next field of the same parity as the current picture 204. The previous, current and next video fields of the same parity may be referred to as consecutive video pictures.

Pixels in consecutive video pictures are said to be collocated when having the same picture location, that is, . . . , Pₙ₋₁(x,y), Pₙ(x,y), Pₙ₊₁(x,y), . . . , where Pₙ₋₁ indicates a pixel value in the previous video picture 202, Pₙ indicates a pixel value in the current video picture 204, Pₙ₊₁ indicates a pixel value in the next video picture 206, and (x,y) is the common picture location between pixels. As shown in FIG. 2, for the picture location, (x,y) is such that x=0, 1, . . . , W−1 and y=0, 1, . . . , H−1, where W is the picture width and H is the picture height, for example.

Operations of the video processing block 102 in FIG. 1 need not be limited to the use of exemplary consecutive video pictures as illustrated in FIG. 2. For example, the video processing block 102 may perform filtering operations on consecutive video fields of the same parity, that is, on consecutive top fields or consecutive bottom fields. When performing noise reduction operations on consecutive video fields of the same parity, pixels in the video processing block 102 are said to be collocated when having the same picture location, that is, . . . , Pₙ₋₁(x,y), Pₙ(x,y), Pₙ₊₁(x,y), . . . , where Pₙ₋₁ indicates a pixel value in a previous video field, Pₙ indicates a pixel value in a current video field, Pₙ₊₁ indicates a pixel value in a next video field, and (x,y) is the common picture location between pixels.

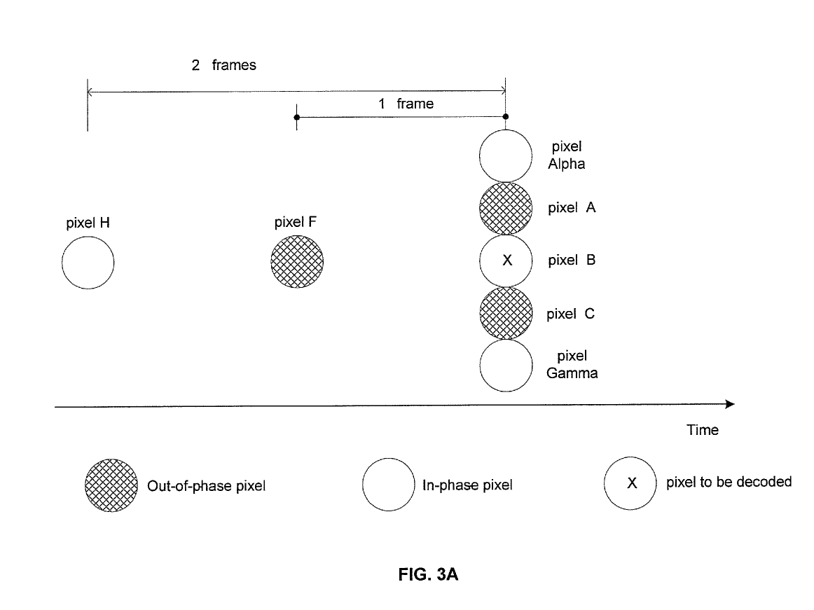

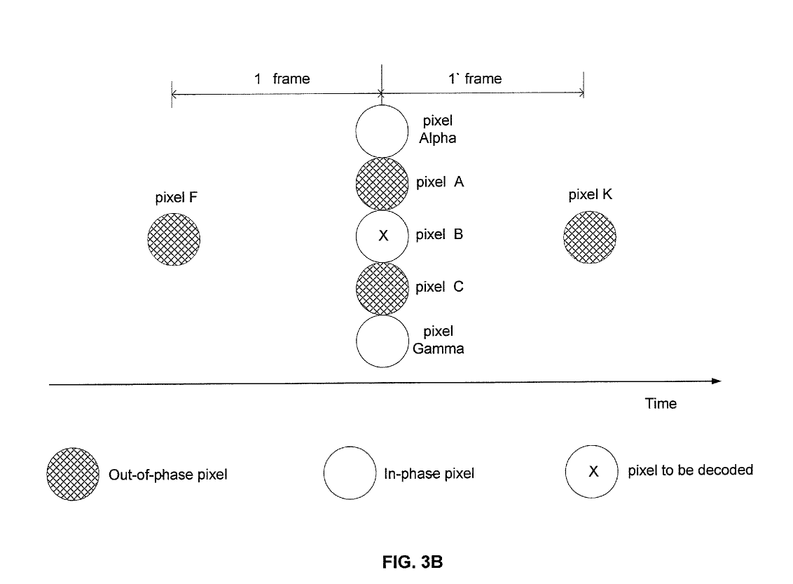

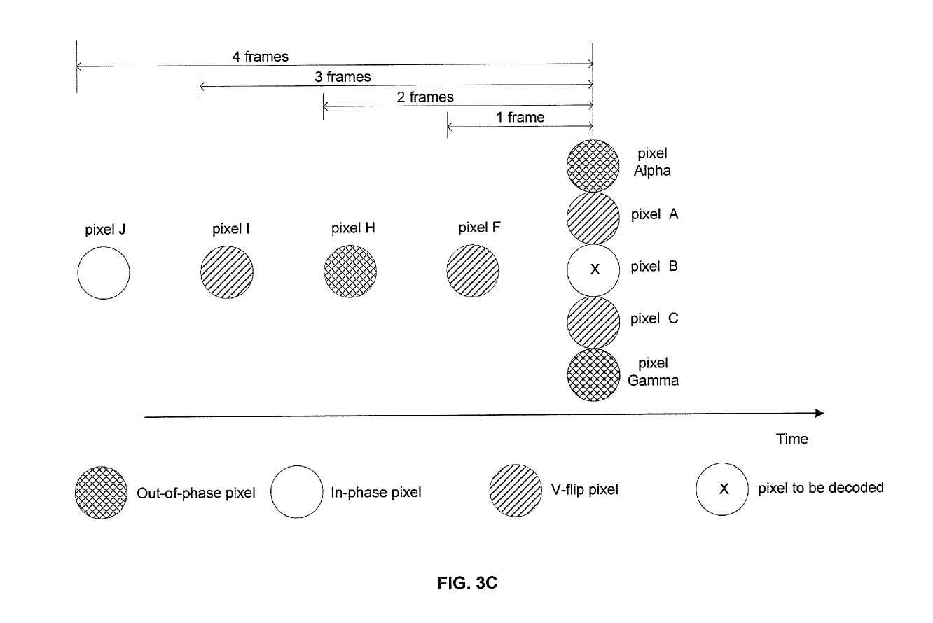

FIG. 3A is a diagram of an exemplary embodiment of a distribution of NTSC composite video baseband pixels in spatial and temporal domains, in accordance with an embodiment of the invention. Referring to FIG. 3A, there is shown a plurality of pixels, pixel alpha, pixel A, pixel B, pixel C, pixel gamma, pixel F, and pixel H of a composite video baseband signal in spatial and temporal domains for the NTSC standard.

In accordance with an embodiment of the invention, the luma component (Y) and the chroma component (C) of a current pixel of a composite video baseband signal, for example, pixel B may be generated. The plurality of pixels, pixel B, pixel alpha, pixel gamma and pixel H may be in-phase, for example. The plurality of pixels, pixel A, pixel C and pixel F may be out of phase, for example. Pixel F may correspond to a pixel from a previous frame, and Pixel H may correspond to a pixel from two frames previous to the current frame of the composite video baseband signal, for example.

FIG. 3B is a diagram of an exemplary embodiment of a distribution of NTSC composite video baseband pixels in spatial and temporal domains with one frame delay, in accordance with an embodiment of the invention. Referring to FIG. 3B, there is shown a plurality of pixels, pixel alpha, pixel A, pixel B, pixel C, pixel gamma, pixel F, and pixel K of a composite video baseband signal in spatial and temporal domains for the NTSC standard.

In accordance with an embodiment of the invention, the luma component (Y) and the chroma component (C) of a current pixel of a composite video baseband signal, for example, pixel B may be generated using one or more future frames. The plurality of pixels, pixel B, pixel alpha, and pixel gamma may be in-phase, for example. The plurality of pixels, pixel A, pixel C, pixel F and pixel K may be out of phase, for example. Pixel F may correspond to a pixel from a previous frame, and Pixel K may correspond to a pixel from a next frame of the composite video baseband signal, for example.

FIG. 3C is a diagram of an exemplary embodiment of a distribution of PAL composite video baseband pixels in spatial and temporal domains, in accordance with an embodiment of the invention. Referring to FIG. 3C, there is shown a plurality of pixels, pixel alpha, pixel A, pixel B, pixel C, pixel gamma, pixel F, pixel H, pixel I and pixel J of a composite video baseband signal in spatial and temporal domains for the PAL standard.

In accordance with an embodiment of the invention, the luma component (Y) and the chroma component (C) of a current pixel of a composite video baseband signal, for example, pixel B may be generated. The plurality of pixels, pixel B and pixel J may be in-phase, for example. The plurality of pixels, pixel alpha, pixel gamma and pixel H may be out of phase, for example. The plurality of pixels, pixel A, pixel C, pixel F and pixel I may be vertical flip (V-flip) pixels, for example. Pixel F may correspond to a pixel from a previous frame, Pixel H may correspond to a pixel from two frames previous to the current frame, Pixel I may correspond to a pixel from three frames previous to the current frame, and Pixel J may correspond to a pixel from four frames previous to the current frame of the composite video baseband signal, for example.

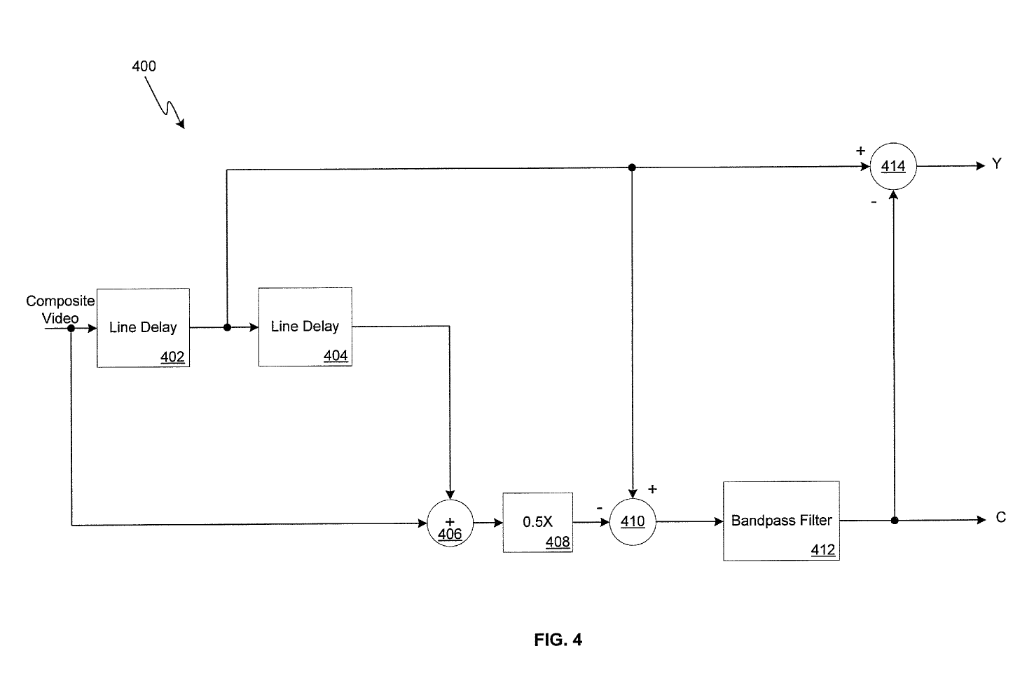

FIG. 4 is a block diagram of an exemplary spatial comb filter for Y/C separation operations, in accordance with an embodiment of the invention. Referring to FIG. 4, there is shown an exemplary spatial comb filter 400. The spatial comb filter 400 may comprise a plurality of line delays 402 and 404, a plurality of summers 406, 10, and 414, a divider 408 and a bandpass filter 412.

The bandpass filter 412 may comprise suitable logic, circuitry, interfaces, and/or code that may be operable to allow a specific set of frequencies and attenuate a remaining set of frequencies. The plurality of line delays 402 and 404 may comprise suitable logic, circuitry, interfaces, and/or code that may be operable to delay a sample of the received composite video baseband signal by a time period.

In operation, the composite video baseband signal may be input to a first line delay 402 and a summer 406. The output of first line delay 402 may pass to a second line delay 404 and the summers 410 and 414. The output of the second line delay 404 may pass to the input of the summer 406. The summer 406 may be operable to generate a double-amplitude composite video baseband signal since the subcarriers are in-phase. A divider 408 (i.e., 0.5 multiplier) may be used to normalize the signal, which may be then input to the negative input of summer 410. Since a 180° phase difference exists between the output of summer 406 and the one line-delayed composite video signal, most of the luminance may be canceled by the invert adder 410, leaving the chrominance. The output of the summer 410 may be input to the bandpass filter 412. The bandpass filter 412 may be operable to generate the chroma component of the composite video baseband signal. The summer 414 may be operable to receive the line delayed composite video baseband signal and subtract the generated chroma component of the composite video baseband signal to generate the luma component of the composite video baseband signal. Notwithstanding, the invention may not be so limited and other architectures may be utilized for spatial comb filtering operations without limiting the scope of the invention.

In accordance with an embodiment of the invention, the spatial comb filter 400 may be operable to receive pixels of current frame video lines of a composite video baseband signal and utilize the received pixels to generate a spatial luma component (Y_{—}2D_comb) and a spatial chroma component (C_{—}2D_comb) of the current pixel, for example, Pixel B of the composite video baseband signal.

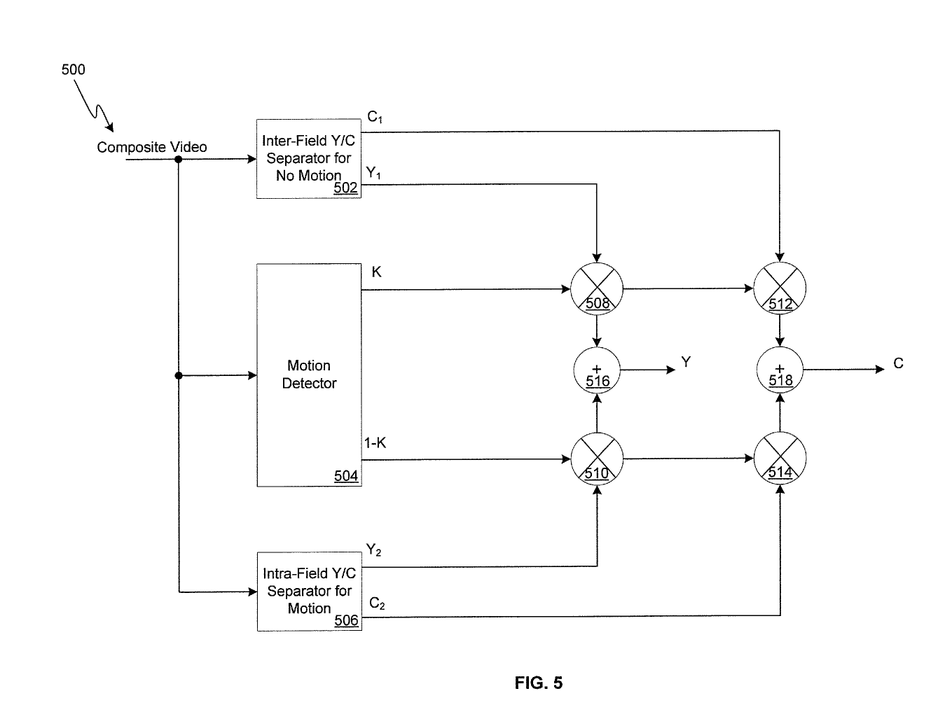

FIG. 5 is a block diagram of an exemplary 3D motion adaptive temporal comb filter for Y/C separation operations, in accordance with an embodiment of the invention. Referring to FIG. 5, there is shown an exemplary temporal 3D_comb filter 500. The temporal 3D_comb filter 500 may comprise an inter-field Y/C separator 502, a motion detector 504, an inter-field Y/C separator 506, a plurality of multipliers 508, 510, 512, and 514, and a plurality of summers 516 and 518.

The inter-field Y/C separator 502 may comprise suitable logic, circuitry, interfaces, and/or code that may be operable to receive a composite video baseband signal and perform 3D comb filtering operations for Y/C separation for still areas, or for video signals without motion, for example. The inter-field Y/C separator 502 may be operable to receive the composite video baseband signal and generate the luma component Y₁ and the chroma component C₁ of the composite video baseband signal. The intra-field Y/C separator 506 may comprise suitable logic, circuitry, interfaces, and/or code that may be operable to receive a composite video baseband signal and perform 2D comb filtering operations for Y/C separation for areas of the picture that may contain motion, or for video signals with motion, for example. The intra-field Y/C separator 506 may be operable to receive the composite video baseband signal and generate the luma component Y₂ and the chroma component C₂ of the composite video baseband signal.

The motion detector 504 may comprise suitable logic, circuitry, interfaces, and/or code that may be operable to receive a composite video baseband signal and generate a motion signal value (K), where K is in the range [0-1]. The motion detector 504 may be operable to allow the luminance and chrominance signals from the inter-field Y/C separator 502 and the inter-field Y/C separator 506 to be proportionally mixed.

The multiplier 508 may comprise suitable logic, circuitry, interfaces, and/or code that may be operable to receive as inputs, the luma component Y₁ and the motion signal value K and generate an output KY₁ to the multiplier 512 and the summer 516. The multiplier 512 may comprise suitable logic, circuitry, interfaces, and/or code that may be operable to receive as inputs, the chroma component C₁ and the output of the multiplier 508, KY₁ and generate an output KY₁C₁ to the summer 518.

The multiplier 510 may comprise suitable logic, circuitry, interfaces, and/or code that may be operable to receive as inputs, the luma component Y₂ and the motion signal value (1−K) and generate an output (1−K)Y₂ to the multiplier 514 and the summer 516. The multiplier 514 may comprise suitable logic, circuitry, interfaces, and/or code that may be operable to receive as inputs, the chroma component C₂ and the output of the multiplier 510, (1−K)Y₂ and generate an output (1−K)Y₂C₂ to the summer 518.

The summer 516 may comprise suitable logic, circuitry, interfaces, and/or code that may be operable to receive as inputs, the output of the multiplier 508, KY₁ and the output of the multiplier 510, (1−K)Y₂ to generate the luma component Y of the composite video baseband signal.

The summer 518 may comprise suitable logic, circuitry, interfaces, and/or code that may be operable to receive as inputs, the output of the multiplier 512, KY₁C₁ and the output of the multiplier 514, (1−K)Y₂C₂ to generate the chroma component C of the composite video baseband signal.

In accordance with an embodiment of the invention, the temporal 3D comb filter 500 may be operable to receive pixels of previous frame, current frame, and future frame video lines of a composite video baseband signal and utilize the received pixels to generate a temporal luma component (Y_{—}3D_comb) and a temporal chroma component (C_{—}3D_comb) of the current pixel, for example, Pixel B of the composite video baseband signal.

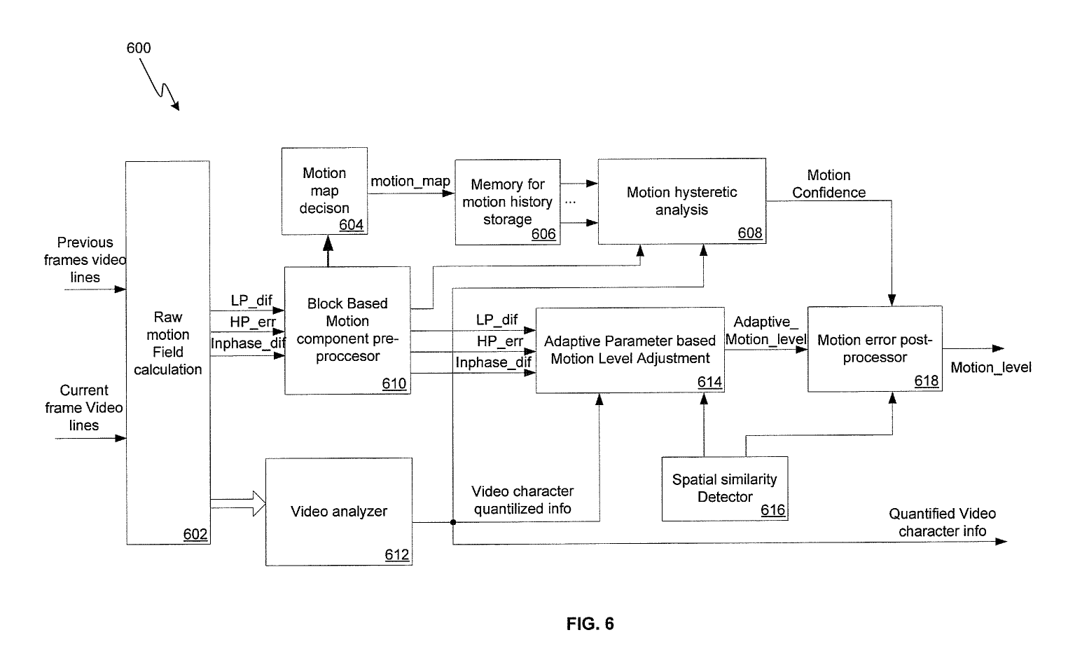

FIG. 6 is a block diagram of an exemplary advanced motion detection system for Y/C separation operations, in accordance with an embodiment of the invention. Referring to FIG. 6, there is shown an exemplary motion detection system 600. The motion detection system 600 may comprise a raw motion field calculation block 602, a motion map decision block 604, a memory 606, a motion hysteretic analysis block 608, a block based motion component pre-processor 610, a video analyzer 612, an adaptive parameter based motion level adjustment block 614, a spatial similarity detector, and a motion error post-processor 618.

The raw motion field calculation block 602 may comprise suitable logic, circuitry, interfaces, and/or code that may be operable to receive pixels of current frame video lines and previous frames' video lines of a composite video baseband signal. The low pass frequency luminance value (LP_dif) may be calculated between a current pixel, for example, Pixel B and a previous frame pixel, for example, Pixel F or Pixel H. The raw motion field calculation block 602 may be operable to generate the low pass frequency luminance value (LP_dif) of the current pixel, for example, Pixel B of the composite video baseband signal based on the following equations:

For the NTSC standard, LP_{—}Dif(n)=∥B_{LP}(n)−F_{LP}(n)∥²_{FILT}

For the PAL standard, LP_{—}Dif(n)=∥B_{LP}(n)−H_{LP}(n)∥²_{FILT}

where B_{LP}(n), F_{LP}(n) and H_{LP}(n) are low pass filtered outputs of Pixel B, Pixel F and Pixel H respectively.

The high pass energy value (HP_err) may be calculated as a difference in sensitivities of the high pass portions of current pixel, for example, Pixel B and out of phase pixels, for example, Pixel F or Pixel H. The raw motion field calculation block 602 may be operable to generate the high pass energy value (HP_err) of the current pixel, for example, Pixel B of the composite video baseband signal based on the following equations:

For the NTSC standard, HP_err(n)=min{∥B_{HP}(n)−F_{HP}(n)∥²,∥B_{HP}(n)+F_{HP}(n)∥²}_{FILT}

For the PAL standard, HP_err(n)=min{∥B_{HP}(n)−H_{HP}(n)∥²,∥B_{HP}(n)+H_{HP}(n)∥²}_{FILT}

where B_{HP}(n), F_{HP}(n) and H_{HP}(n) are high pass filtered outputs of Pixel B, Pixel F and Pixel H respectively.

The phase difference value (Inphase_dif) may be calculated as an in-phase frame pixel difference between a current pixel, for example, Pixel B and another in-phase pixel, for example, Pixel F or Pixel J. The raw motion field calculation block 602 may be operable to generate the phase difference value (Inphase_dif) of the current pixel, for example, Pixel B of the composite video baseband signal based on the following equations:

For the NTSC standard, Inphase_dif(n)=∥B(n)−F(n)∥²_{FILT}

For the PAL standard with 4 frame delay, Inphase_dif(n)=∥B(n)−J(n)∥²_{FILT}

For the PAL standard with 3 frame delay, Inphase_dif(n)=∥B(n)+H(n)−F(n)−I(n)∥²_{FILT}

where B(n), F(n), H(n) and J(n) are the FIR filtered outputs of Pixel B, Pixel F, Pixel H and Pixel J respectively to remove the high frequency interference.

The block based motion component pre-processor 610 may comprise suitable logic, circuitry, interfaces, and/or code that may be operable to receive the generated low pass frequency luminance value (LP_dif), a high pass energy level value (HP_err), and a phase difference value (Inphase_dif) of the current pixel, for example, Pixel B of the composite video baseband signal. The block based motion component pre-processor 610 may be operable to filter the received low pass frequency luminance value (LP_dif), a high pass energy level value (HP_err), and a phase difference value (Inphase_dif) of the current pixel, for example, Pixel B of the composite video baseband signal to remove noise and interference, for example.

The video analyzer 612 may comprise suitable logic, circuitry, interfaces, and/or code that may be operable to receive a plurality of video characteristics, such as a high pass energy level, a chroma bandwidth, temporal domain motion history, a texture, a color level, an intensity, a brightness, and/or a saturation of the current pixel, for example, Pixel B and one or more previous pixels, for example, Pixel F and/or Pixel H of the composite video baseband signal. The video analyzer 612 may be operable to generate a quantized output D(n) of the plurality of video characteristics to the adaptive parameter based motion level adjustment block 614 and the motion hysteretic analysis block 608.

The spatial similarity detector 616 may comprise suitable logic, circuitry, interfaces, and/or code that may be operable to receive the current frame video lines of the composite video baseband signal and generate spatial similarity level (sim_spatial) to the adaptive parameter based motion level adjustment block 614 and the motion error post-processor 618.

The adaptive parameter based motion level adjustment block 614 may comprise suitable logic, circuitry, interfaces, and/or code that may be operable to receive the filtered low pass frequency luminance value (LP_dif), a high pass energy level value (HP_err), and a phase difference value (Inphase_dif) of the current pixel, for example, Pixel B of the composite video baseband signal.

The adaptive parameter based motion level adjustment block 614 may be operable to generate an adaptive motion level (adaptive_motion_level) of the current pixel, for example, Pixel B of the composite video baseband signal based on the generated low pass frequency luminance value(LP_dif), high pass energy level value (HP_err), and the phase difference value (Inphase_dif), and the one or more video characteristics of the current pixel, for example, Pixel B of the composite video baseband signal.

In accordance with an embodiment of the invention, the adaptive motion level (adaptive_motion_level) of the current pixel, for example, Pixel B of the composite video baseband signal may be generated according to the following equation:

adaptive_motion_level(n)=F4{G1(n)*F1(LP_Dif(n),C1(n))+G2(n)*F2(HP_err(n),C2(n))+G3(n)*F3(Inphase_dif(n),C3(n))}

where, G1(n), G2(n) and G3(n) are adaptive programmable parameters that may be tuned, C1(n), C2(n) and C3(n) are adaptive components calculated by the video analyzer 612 based on the plurality of video characteristics. For example, in accordance with an embodiment of the invention, in instances where the content of an image has a higher level of detail or texture, the contents are with a lot of details/texture, the video analyzer 612 may be operable to increase the value of C3(n) to reduce the sensitivity of the adaptive_motion_level to the Inphase_dif value. The components C1(n), C2(n) and C3(n) may be calculated according to the following equations:

C1(n)=F1_{—}c{D(n)};C2(n)=F2_{—}c{D(n)};C3(n)=F3_{—}c{D(n)}.

The parameters G1(n), G2(n) and G3(n) may be calculated according to the following equations:

G1(n)=F1_{—}g{D(n)};G2(n)=F2_{—}g{D(n)};G3(n)=F3_{—}g{D(n)}.

where F1˜F3 are programmable functions. For example, in accordance with an embodiment of the invention, in instances where the Inphase_dif value is lesser than a threshold value, the functions, F3_c and F3_g may be set to zero.

For the NTSC standard, the function F1 may be calculated according to the following equations:

F1_{—}c{D(n)}=K11*max{0,min{∥B_{HP}(n)+F_{HP}(n)∥²_{LPF},∥H_{HP}(n)+F_{HP}(n)∥²_{LPF}}−Th11}+K12*max{0,∥B_{HP}(n)∥²_{LPF}−Th12}+K13*max{0,min{∥B(n)−alpha(n)∥²_{LPF},∥B(n)−gamma(n)∥²_{LPF}}−Th13}

F1(LP_Dif(n),C1(n))=∥LP_Dif(n)−F1_{—}c{D(n)}∥²_{LPF}

where K11, K12, and K13 are programmable scaling factors and Th11, Th12 and Th13 are programmable threshold values.

Similarly, for the NTSC standard, the function F2 may be calculated according to the following equations:

F2_{—}c{D(n)}=K21*∥B_{HP}(n)+F_{HP}(n)∥²_{LPF}+K22*sim_{—}2D;

F2(HP_err(n),C2(n))=∥HP_err(n)−F2_{—}c{D(n)}∥²_{LPF}

where K21 and K22 are programmable scaling factors.

For the NTSC standard, the function F3 may be calculated according to the following equations:

F3_{—}c{D(n)}=min{[K31*max{0,min{∥B_{HP}(n)+F_{HP}(n)∥²_{LPF},∥H_{HP}(n)+F_{HP}(n)∥²_{LPF}}−Th31}+K32*max{0,∥B_{HP}(n)∥²_{LPF}−Th32}],K33*max{0,min{∥B(n)−alpha(n)∥²_{LPF},∥B(n)−gamma(n)∥²_{LPF}}−Th33}}

F3(Inphase_dif(n),C3(n))=∥max{Inphase_dif(n)−F3_{—}c{D(n)},0}∥²_{LPF}

where K31, K32, and K33 are programmable scaling factors and Th31, Th32 and Th33 are programmable threshold values.

Accordingly, the adaptive motion level may calculated according to the following equation:

adaptive_motion_level(n)=0 for still pictures;

adaptive_motion_level(n)=255 or maximum value for motion pictures; and

adaptive_motion_level(n)=K4*{(G1(n)*F1(LP_Dif(n),C1(n))+G2(n)*(F2(HP_err(n),C2(n))+G3(n)*(F3(Inphase_dif(n),C3(n))} for other pictures.

where K4 may be a programmable scaling factor that may be calculated according to the following equation:

K4=min{max(G41*sim_{—}2D−Th41,0)_{LPF}+offset41, limit41}.

The motion map decision block 604 may comprise suitable logic, circuitry, interfaces, and/or code that may be operable to receive the generated low pass frequency luminance value (LP_dif), a high pass energy level value (HP_err), and a phase difference value (Inphase_dif) of the current pixel, for example, Pixel B of the composite video baseband signal. The motion map decision block 604 may be operable to generate motion_map value to the memory 606. The motion map decision block 604 may be operable to generate the motion_map value according to the following equation:

motion_map(n)=Inphase_dif(n)>[F3_{—}c {D(n)}+offset05], where offset05 is a programmable offset parameter.

The memory 606 may comprise suitable logic, circuitry, interfaces, and/or code that may be operable to store the received motion_map value from the motion map decision block 604 for the current pixel, for example, Pixel B and one or more previous pixels, for example, Pixel F and/or Pixel H of the composite video baseband signal. The memory 606 may be operable to store the temporal domain motion history of the current pixel, for example, Pixel B and one or more previous pixels, for example, Pixel F and/or Pixel H of the composite video baseband signal.

The motion hysteretic analysis block 608 may comprise suitable logic, circuitry, interfaces, and/or code that may be operable to receive the stored motion_map values from the memory 606. The motion hysteretic analysis block 608 may be operable to receive the generated low pass frequency luminance value (LP_dif), a high pass energy level value (HP_err), and a phase difference value (Inphase_dif) of the current pixel, for example, Pixel B of the composite video baseband signal from the block based motion component pre-processor 610. The motion hysteretic analysis block 608 may be operable to receive the quantized video characteristics from the video analyzer 612.

The motion hysteretic analysis block 608 may be operable to generate a motion confidence value (motion_confidence) based on the temporal domain motion history of the current pixel, for example, Pixel B and one or more previous pixels, for example, Pixel F and/or Pixel H of the composite video baseband signal, the plurality of quantized video characteristics and the generated low pass frequency luminance value (LP_dif), a high pass energy level value (HP_err), and a phase difference value (Inphase_dif) of the current pixel, for example, Pixel B of the composite video baseband signal. The motion hysteretic analysis block 608 may be operable to bias the generated adaptive motion level by forcing the adaptive_motion_level(n) value to zero or a maximum value. For example, in accordance with an embodiment of the invention, in instances where a previous field or frame is with motion, and if the current frame does not detect any motion, it may be assumed that the current pixel, for example, Pixel B is with motion. Similarly, if a previous field or frame is detected without any motion and in instances where the current frame's Inphase_dif is less than a threshold value, and if the current motion_level value is higher than a threshold value, the motion_level value may be set to zero.

The motion error post-processor 618 may comprise suitable logic, circuitry, interfaces, and/or code that may be operable to receive the motion confidence value (motion_confidence) from the motion hysteretic analysis block 608. The motion error post-processor 618 may be operable to receive the adaptive motion level value (adaptive_motion_level) from the adaptive parameter based motion level adjustment block 614. The motion error post-processor 618 may be operable to receive the spatial similarity level (sim_spatial) from the spatial similarity detector 616. The motion error post-processor 618 may be operable to generate the motion level (motion_level) of the current pixel, for example, Pixel B of the composite video baseband signal based on the generated adaptive motion level (adaptive_motion_level), the generated motion confidence value (motion_confidence) and a generated spatial similarity level (sim_spatial) of the current pixel, for example, Pixel B of the composite video baseband signal. For example, in accordance with an embodiment of the invention, if the generated spatial similarity level (sim_spatial) is higher than a threshold value, the motion_level(n) may be biased towards a non-zero level.

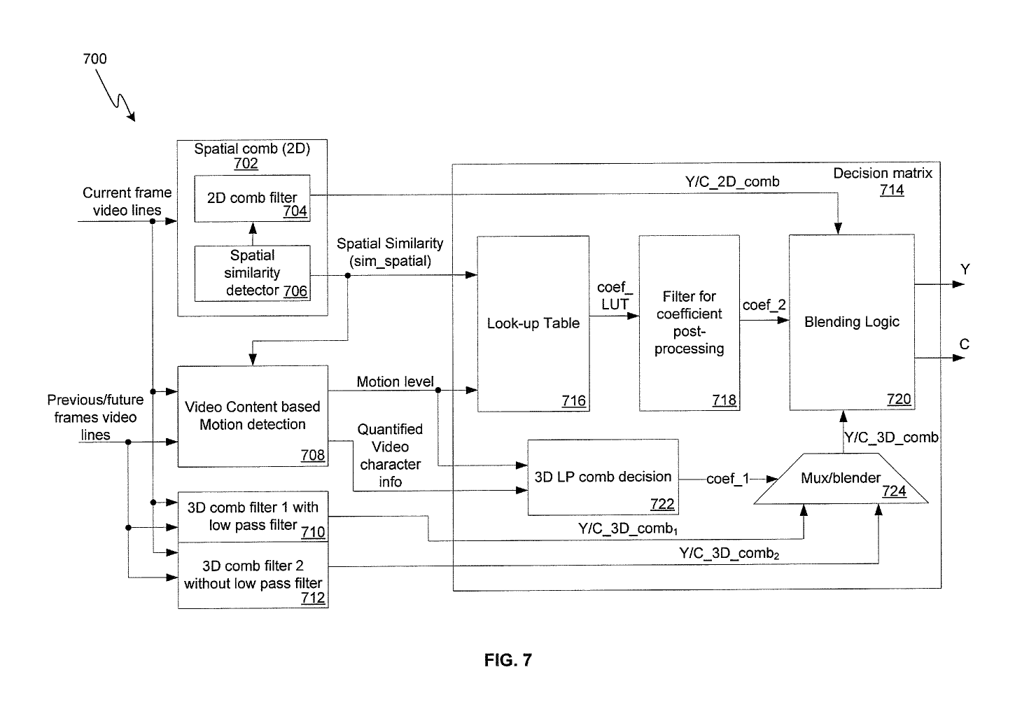

FIG. 7 is a block diagram of an exemplary advanced motion detection and decision mechanism for a comb filter in an analog video decoder for Y/C separation operations, in accordance with an embodiment of the invention. Referring to FIG. 7, there is shown an exemplary video decoder 700. The video decoder 700 may comprise a spatial comb filter 702, a video content based motion detection block 708, a plurality of temporal comb filters 710 and 712, and a decision matrix 714. The decision matrix 714 may comprise a look-up table 716, a filter 718, a blending logic block 720, a low pass comb decision block 722 and a MUX/blender 724.

The spatial comb filter 702 may comprise a 2D comb filter 704 and a spatial similarity detector 706. The 2D comb filter 704 may comprise suitable logic, circuitry, interfaces, and/or code that may be operable to receive pixels of current frame video lines of a composite video baseband signal and utilize the received pixels to generate a spatial luma component (Y_{—}2D_comb) and a spatial chroma component (C_{—}2D_comb) of the current pixel, for example, Pixel B of the composite video baseband signal.

The spatial similarity detector 706 may comprise suitable logic, circuitry, interfaces, and/or code that may be operable to receive the current frame video lines of the composite video baseband signal and generate a spatial similarity level (sim_spatial) to the video content based motion detection block 708 and the decision matrix 714.

The video content based motion detection block 708 may comprise suitable logic, circuitry, interfaces, and/or code that may be operable to receive the current frame video lines and previous frames' video lines of the composite video baseband signal and the spatial similarity level (sim_spatial) from the spatial similarity detector 706. The video content based motion detection block 708 may be operable to generate the motion level (motion_level) and the quantized video characteristics. The video content based motion detection block 708 may be similar to the motion detection system 600 and substantially as described in FIG. 6.

The temporal comb filter 710 may comprise suitable logic, circuitry, interfaces, and/or code that may be operable to receive pixels of previous, current and future frames of video lines of a composite video baseband signal and utilize these pixels to generate temporal luma component (Y_{—}3D_comb₁) and temporal chroma component (C_{—}3D_comb₁) of the current pixel, for example, Pixel B of the composite video baseband signal. The temporal comb filter 710 may be similar to the temporal 3D comb filter mode 500 and substantially as described in FIG. 5. The temporal comb filter 710 may comprise a low pass filter, for example. The temporal luma component (Y_{—}3D_comb₁) may be generated according to the following equations:

For the NTSC standard, Y_{—}3D_comb₁=B(n)+F(n)

For the PAL standard, Y_{—}3D_comb₁=B(n)+H(n)

The temporal chroma component (C_{—}3D_comb₁) may be generated according to the following equations:

For the NTSC standard, C_{—}3D_comb₁=B(n)−F(n)

For the PAL standard, C_{—}3D_comb₁=B(n)−H(n)

The temporal comb filter 712 may comprise suitable logic, circuitry, interfaces, and/or code that may be operable to receive pixels of previous, current and future frames of video lines of a composite video baseband signal and utilize these pixels to generate temporal luma component (Y_{—}3D_comb₂) and temporal chroma component (C 3D_comb₂) of the current pixel, for example, Pixel B of the composite video baseband signal. The temporal comb filter 712 may be similar to the temporal 3D comb filter mode 500 and substantially as described in FIG. 5. The temporal comb filter 712 may not comprise a low pass filter, for example. The temporal luma component (Y 3D_comb₂) may be generated according to the following equations:

For the NTSC standard, Y_{—}3D_comb₂=B_{LP}(n)+B_{HP}(n)+F_{HP}(n)

For the PAL standard, Y_{—}3D_comb₂=B_{LP}(n)+B_{HP}(n)+H_{HP}(n)

The temporal chroma component (C_{—}3D_comb₂) may be generated according to the following equations:

For the NTSC standard, C_{—}3D_comb₂=B_{HP}(n)−F_{HP}(n)

For the PAL standard, C_{—}3D_comb₂=B_{HP}(n)−H_{HP}(n)

The low pass comb decision block 722 may comprise suitable logic, circuitry, interfaces, and/or code that may be operable to receive the generated motion level and the quantized video characteristics from the video content based motion detection block 708 and generate a first coefficient (coef_{—}1). The value of coef_{—}1 may be calculated according to the following equations:

coef_{—}1=0, if Inphase_dif(n)>Th61, or motion_level(n)>Th62

coef_{—}1=256 or a maximum value, if motion_level(n)>Th63

coef_{—}1=K6*motion_level(n), otherwise,

where K6 is a programmable scaling factor and Th61, Th62, and Th63 are programmable threshold values.

The MUX/blender 724 may comprise suitable logic, circuitry, interfaces, and/or code that may be operable to receive the generated first coefficient (coef_{—}1) from the low pass comb decision block 722. The MUX/blender 724 may be operable to receive the generated temporal luma component (Y_{—}3D_comb₁) and temporal chroma component (C_{—}3D_comb₁) of the current pixel, for example, Pixel B of the composite video baseband signal from the temporal comb filter 710. The MUX/blender 724 may be operable to receive the generated temporal luma component (Y_{—}3D_comb₂) and temporal chroma component (C_{—}3D_comb₂) of the current pixel, for example, Pixel B of the composite video baseband signal from the temporal comb filter 712.

The MUX/blender 724 may be operable to generate a temporal luma component (Y_{—}3D_comb) and a temporal chroma component (C_{—}3D_comb) of the current pixel, for example, Pixel B of the composite video baseband signal based on selecting one of the luma components, for example, Y_{—}3D_comb₁ and Y_{—}3D_comb₂ and the corresponding chroma components, for example, C_{—}3D_comb₁ and C_{—}3D_comb₂ corresponding to the generated first coefficient (coef_{—}1).

In accordance with another embodiment of the invention, the MUX/blender 724 may be operable to generate a temporal luma component (Y_{—}3D_comb) and a temporal chroma component (C_{—}3D_comb) of the current pixel, for example, Pixel B of the composite video baseband signal based on blending the luma components, for example, Y_{—}3D_comb₁ and Y_{—}3D_comb₂ and the corresponding chroma components, for example, C_{—}3D_comb₁ and C_{—}3D_comb₂ with the generated first coefficient (coef_{—}1). For example, temporal luma component (Y_{—}3D_comb) and a temporal chroma component (C_{—}3D_comb) of the current pixel, for example, Pixel B of the composite video baseband signal may be generated according to the following equation:

Y/C_{—}3D={coef_{—}1*(Y/C_{—}3D_comb₂)+(256−coef_{—}1)*(Y/C_{—}3D_comb₁)}/256

The look-up table 716 may comprise information that may be stored in memory 106 and may receive as inputs, the spatial similarity level (sim_spatial) and the motion level of the current pixel, for example, Pixel B of the composite video baseband signal. The processor 104 may be operable to utilize the stored similarity levels in the look-up table 716 to generate a corresponding coefficient, for example, coef_LUT.

The filter 718 may comprise suitable logic, circuitry, interfaces, and/or code that may be operable to receive the generated coefficient (coef_LUT) from the look-up table 716. The filter 718 may be operable to low pass filter the generated coefficient (coef_LUT) to generate a second coefficient (coef_{—}2).

The blending logic block 720 may comprise suitable logic, circuitry, interfaces, and/or code that may be operable to receive the generated second coefficient (coef_{—}2) from the filter 718. The blending logic block 720 may be operable to receive the generated spatial luma component (Y_{—}2D_comb) and the generated spatial chroma component (C_{—}2D_comb) of the current pixel, for example, Pixel B of the composite video baseband signal from the spatial comb filter 702. The blending logic block 720 may be operable to receive the generated temporal luma component (Y_{—}3D_comb) and the generated temporal chroma component (C_{—}3D_comb) of the current pixel, for example, Pixel B of the composite video baseband signal from the MUX/blender 724. The blending logic block 720 may be operable to generate the luma component (Y) and the chroma component (C) of the current pixel, for example, Pixel B of the composite video baseband signal based on blending the generated second coefficient (coef_{—}2) with the determined spatial luma component (Y_{—}2D_comb), the determined spatial chroma component (C_{—}2D_comb), the determined temporal luma component (Y_{—}3D_comb), and the determined temporal chroma component (C_{—}3D_comb) of the current pixel, for example, Pixel B of the composite video baseband signal. In accordance with another embodiment of the invention, the blending logic block 720 may comprise one or more fuzzy logic circuits that may be operable to blend non-linear values of the determined spatial luma component (Y_{—}2D_comb), the determined spatial chroma component (C_{—}2D_comb), the determined temporal luma component (Y_{—}3D_comb), and the determined temporal chroma component (C_{—}3D_comb) of the current pixel, for example, Pixel B of the composite video baseband signal with the generated second coefficient (coef_{—}2).

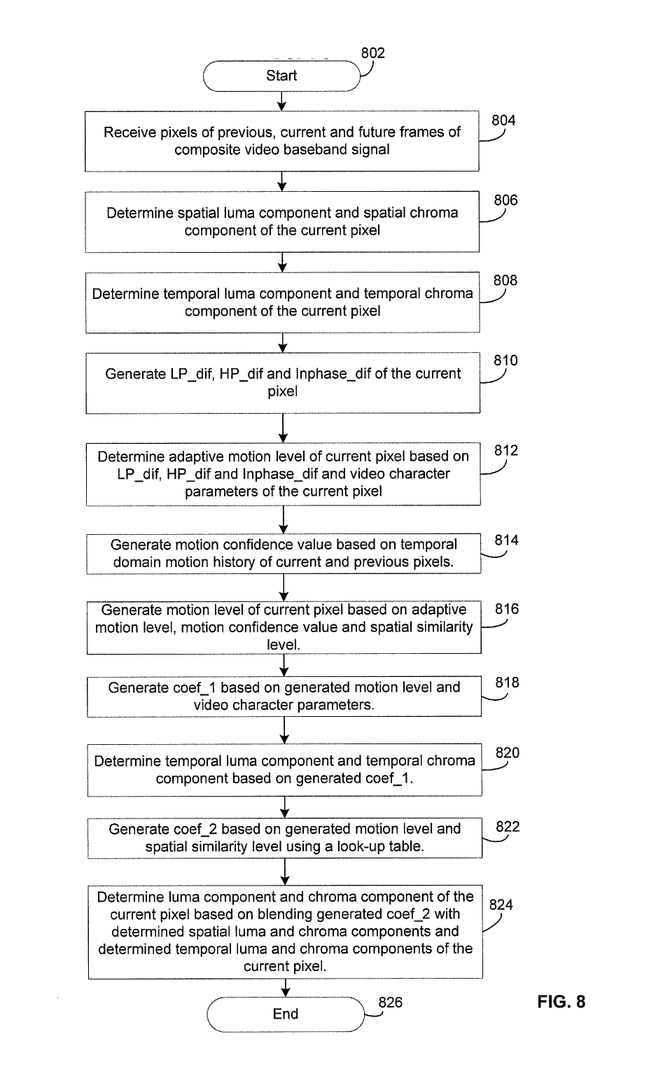

FIG. 8 is a flowchart illustrating exemplary steps for a generalized multi-dimensional filter device for Y/C separation operations, in accordance with an embodiment of the invention. Referring to FIG. 8, exemplary steps may begin at step 802. In step 804, a plurality of previous, current, and future samples of the composite video baseband signal may be received. In step 806, a spatial luma component (Y_{—}2D_comb) and a spatial chroma component (C_{—}2D_comb) of a current pixel, for example, Pixel B of a composite video baseband signal may be determined. In step 808, a temporal luma component (Y_{—}3D_comb) and a temporal chroma component (C_{—}3D_comb) of the current pixel, for example, Pixel B of the composite video baseband signal may be determined. In step 810, a low pass frequency luminance value (LP_dif), a high pass energy level value (HP_err), and a phase difference value (Inphase_dif) of the current pixel, for example, Pixel B of the composite video baseband signal may be generated. In step 812, an adaptive motion level (adaptive_motion_level) of the current pixel, for example, Pixel B of the composite video baseband signal may be generated based on the generated low pass frequency luminance value(LP_dif), high pass energy level value (HP_err), and the phase difference value (Inphase_dif), and the one or more video characteristics of the current pixel, for example, Pixel B of the composite video baseband signal. The video characteristics may comprise one or more of a high pass energy level, a chroma bandwidth, temporal domain motion history, a texture, a color level, an intensity, a brightness, and/or a saturation of the current pixel, for example, Pixel B and one or more previous pixels, for example, Pixel F and/or Pixel H of the composite video baseband signal.

In step 814, a motion confidence value (motion_confidence) may be generated based on the temporal domain motion history of the current pixel, for example, Pixel B and one or more previous pixels, for example, Pixel F and/or Pixel H of the composite video baseband signal. In step 816, a motion level (motion_level) of the current pixel, for example, Pixel B of the composite video baseband signal may be generated based on the generated adaptive motion level (adaptive_motion_level), the generated motion confidence value (motion_confidence) and a generated spatial similarity level (sim_{—}2D) of the current pixel, for example, Pixel B of the composite video baseband signal. In step 818, a first coefficient (coef_{—}1) may be generated based on the one or more video characteristics and the generated motion level (motion_level) of the current pixel, for example, Pixel B of the composite video baseband signal. In step 820, the temporal luma component (Y_{—}3D_comb) and the temporal chroma component (C_{—}3D_comb) may be determined based on the generated first coefficient (coef_{—}1). In step 822, a second coefficient (coef_{—}2) may be generated based on the generated spatial similarity level (sim_spatial) and the generated motion level (motion_level) of the current pixel, for example, Pixel B of the composite video baseband signal by utilizing a look-up table 716. In step 824, a luma component (Y) and a chroma component (C) of the current pixel, for example, Pixel B of the composite video baseband signal may be generated based on blending the generated second coefficient (coef_{—}2) with the determined spatial luma component (Y_{—}2D_comb), the determined spatial chroma component (C_{—}2D_comb), the determined temporal luma component (Y_{—}3D_comb), and the determined temporal chroma component (C_{—}3D_comb) of the current pixel, for example, Pixel B of the composite video baseband signal. Control then passes to end step 826.

In accordance with an embodiment of the invention, a method and system for an advanced motion detection and decision mechanism for a comb filter in an analog video decoder may comprise one or more processors and/or circuits, for example, a spatial comb filter 702 that may be operable to determine a spatial luma component (Y_{—}2D_comb) and a spatial chroma component (C_{—}2D_comb) of a current pixel, for example, Pixel B of a composite video baseband signal. The one or more processors and/or circuits, for example, the temporal comb filters 710 and 712 may be operable to determine a temporal luma component (Y_{—}3D_comb) and a temporal chroma component (C_{—}3D_comb) of the current pixel, for example, Pixel B of the composite video baseband signal. The one or more processors and/or circuits, for example, the motion detection system 600 may be operable to generate a motion level (motion_level) of the current pixel, for example, Pixel B based on one or more video characteristics. The video characteristics may comprise one or more of a high pass energy level, a chroma bandwidth, temporal domain motion history, a texture, a color level, an intensity, a brightness, and/or a saturation of the current pixel, for example, Pixel B and one or more previous pixels, for example, Pixel F and/or Pixel H of the composite video baseband signal.

The one or more processors and/or circuits, for example, the video decoder 700 may be operable to generate a luma component (Y) and a chroma component (C) of the current pixel, for example, Pixel B of the composite video baseband signal based on the generated motion level (motion_level), and the determined spatial luma component (Y_{—}2D_comb), determined spatial chroma component (C_{—}2D_comb), determined temporal luma component (Y_{—}3D_comb), and determined temporal chroma component (C_{—}3D_comb) of the current pixel, for example, Pixel B of the composite video baseband signal.

The one or more processors and/or circuits, for example, the motion detection system 600 may be operable to generate a low pass frequency luminance value (LP_dif), a high pass energy level value (HP_err), and a phase difference value (Inphase_dif) of the current pixel, for example, Pixel B of the composite video baseband signal. The one or more processors and/or circuits for example, the motion detection system 600 may be operable to generate an adaptive motion level (adaptive_motion_level) of the current pixel, for example, Pixel B of the composite video baseband signal based on the generated low pass frequency luminance value(LP_dif), high pass energy level value (HP_err), and the phase difference value (Inphase_dif), and the one or more video characteristics of the current pixel, for example, Pixel B of the composite video baseband signal.

The one or more processors and/or circuits, for example, the motion detection system 600 may be operable to generate a motion confidence value (motion_confidence) based on the temporal domain motion history of the current pixel, for example, Pixel B and one or more previous pixels, for example, Pixel F and/or Pixel H of the composite video baseband signal. The one or more processors and/or circuits, for example, the motion detection system 600 may be operable to generate the motion level (motion_level) of the current pixel, for example, Pixel B of the composite video baseband signal based on the generated adaptive motion level (adaptive_motion_level), the generated motion confidence value (motion_confidence) and a generated spatial similarity level (sim_spatial) of the current pixel, for example, Pixel B of the composite video baseband signal.

The one or more processors and/or circuits, for example, the video decoder 700 may be operable to generate a first coefficient (coef_{—}1) based on the one or more video characteristics and the generated motion level (motion_level) of the current pixel, for example, Pixel B of the composite video baseband signal. The one or more processors and/or circuits, for example, the video decoder 700 may be operable to determine the temporal luma component (Y_{—}3D_comb) and the temporal chroma component (C_{—}3D_comb) based on the generated first coefficient (coef_{—}1). The one or more processors and/or circuits, for example, the video decoder 700 may be operable to generate a second coefficient (coef_{—}2) based on the generated spatial similarity level (sim_spatial) and the generated motion level (motion_level) of the current pixel, for example, Pixel B of the composite video baseband signal by utilizing a look-up table 716. The one or more processors and/or circuits, for example, the video decoder 700 may be operable to generate the luma component (Y) and the chroma component (C) of the current pixel, for example, Pixel B of the composite video baseband signal based on blending the generated second coefficient (coef_{—}2) with the determined spatial luma component (Y_{—}2D_comb), the determined spatial chroma component (C_{—}2D_comb), the determined temporal luma component (Y_{—}3D_comb), and the determined temporal chroma component (C_{—}3D_comb) of the current pixel, for example, Pixel B of the composite video baseband signal.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for an advanced motion detection and decision mechanism for 3D comb filter in an analog video decoder.

Accordingly, the present invention may be realized in hardware or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising performing by one or more processors and/or circuits:
determining a spatial luma component and a spatial chroma component of a current pixel of a composite video baseband signal;
determining a temporal luma component and a temporal chroma component of said current pixel of said composite video baseband signal;
generating a motion level of said current pixel based on one or more video characteristics; and
generating a luma component and a chroma component of said current pixel of said composite video baseband signal based on said generated motion level and said determined spatial luma component, said determined spatial chroma component, said determined temporal luma component, and said determined temporal chroma component of said current pixel of said composite video baseband signal.

2. The method according to claim 1, wherein said video characteristics comprises one or more of: a high pass energy level, a chroma bandwidth, temporal domain motion history, a texture, a color level, an intensity, a brightness, and/or a saturation of said current pixel and one or more previous pixels of said composite video baseband signal.

3. The method according to claim 2, comprising generating a low pass frequency luminance value, said high pass energy level value, and a phase difference value of said current pixel of said composite video baseband signal.

4. The method according to claim 3, comprising generating an adaptive motion level of said current pixel of said composite video baseband signal based on said generated low pass frequency luminance value, said generated high pass energy level value, said generated phase difference value and said one or more video characteristics of said current pixel of said composite video baseband signal.

5. The method according to claim 4, comprising generating a motion confidence value based on said temporal domain motion history of said current pixel and said one or more previous pixels of said composite video baseband signal.

6. The method according to claim 5, comprising generating said motion level of said current pixel of said composite video baseband signal based on said generated adaptive motion level, said generated motion confidence value and a generated spatial similarity level of said current pixel of said composite video baseband signal.

7. The method according to claim 6, comprising generating a first coefficient based on said one or more video characteristics and said generated motion level of said current pixel of said composite video baseband signal.

8. The method according to claim 7, comprising determining said temporal luma component and said temporal chroma component based on said generated first coefficient.

9. The method according to claim 8, comprising generating a second coefficient based on said generated spatial similarity level and said generated motion level of said current pixel of said composite video baseband signal by utilizing a look-up table.

10. The method according to claim 9, comprising generating said luma component and said chroma component of said current pixel of said composite video baseband signal based on blending said generated second coefficient with said determined spatial luma component, said determined spatial chroma component, said determined temporal luma component, and said determined temporal chroma component of said current pixel of said composite video baseband signal.

11. A system for video processing, the system comprising:
one or more processors and/or circuits that are operable to:
determine a spatial luma component and a spatial chroma component of a current pixel of a composite video baseband signal;
determine a temporal luma component and a temporal chroma component of said current pixel of said composite video baseband signal;
generate a motion level of said current pixel based on one or more video characteristics; and
generate a luma component and a chroma component of said current pixel of said composite video baseband signal based on said generated motion level and said determined spatial luma component, said determined spatial chroma component, said determined temporal luma component, and said determined temporal chroma component of said current pixel of said composite video baseband signal.

12. The system according to claim 11, wherein said video characteristics comprises one or more of: a high pass energy level, a chroma bandwidth, temporal domain motion history, a texture, a color level, an intensity, a brightness, and/or a saturation of said current pixel and one or more previous pixels of said composite video baseband signal.

13. The system according to claim 12, wherein said one or more processors and/or circuits are operable to generate a low pass frequency luminance value, said high pass energy level value, and a phase difference value of said current pixel of said composite video baseband signal.

14. The system according to claim 13, wherein said one or more processors and/or circuits are operable to generate an adaptive motion level of said current pixel of said composite video baseband signal based on said generated low pass frequency luminance value, said generated high pass energy level value, said generated phase difference value and said one or more video characteristics of said current pixel of said composite video baseband signal.

15. The system according to claim 14, wherein said one or more processors and/or circuits are operable to generate a motion confidence value based on said temporal domain motion history of said current pixel and said one or more previous pixels of said composite video baseband signal.

16. The system according to claim 15, wherein said one or more processors and/or circuits are operable to generate said motion level of said current pixel of said composite video baseband signal based on said generated adaptive motion level, said generated motion confidence value and a generated spatial similarity level of said current pixel of said composite video baseband signal.

17. The system according to claim 16, wherein said one or more processors and/or circuits are operable to generate a first coefficient based on said one or more video characteristics and said generated motion level of said current pixel of said composite video baseband signal.

18. The system according to claim 17, wherein said one or more processors and/or circuits are operable to determine said temporal luma component and said temporal chroma component based on said generated first coefficient.

19. The system according to claim 18, wherein said one or more processors and/or circuits are operable to generate a second coefficient based on said generated spatial similarity level and said generated motion level of said current pixel of said composite video baseband signal by utilizing a look-up table.

20. The system according to claim 19, wherein said one or more processors and/or circuits are operable to generate said luma component and said chroma component of said current pixel of said composite video baseband signal based on blending said generated second coefficient with said determined spatial luma component, said determined spatial chroma component, said determined temporal luma component, and said determined temporal chroma component of said current pixel of said composite video baseband signal.
